(19) United States
(12) Patent Application Publication
(10) Pub. No.: US 2006/0141322 A1
(43) Pub. Date: Jun. 29, 2006

(54) Fuel cell system

(76) Inventors: Nobuhisa Ishida, Kyoto-shi (JP); Kusunoki Higashino, Osaka-shi (JP)

Correspondence Address: SIDLEY AUSTIN LLP, 717 NORTH HARWOOD, SUITE 3400, DALLAS, TX, 75201, US

(21) Appl. No.: 11/319,642

(22) Filed: Dec. 28, 2005

(30) Foreign Application Priority Data
Dec. 28, 2004 (JP) 2004-379095

(51) Int. Cl. H01M 8/02; H01M 8/04; H01M 8/10

(52) U.S. Cl. 429/34; 429/25; 429/30; 429/22

(57) ABSTRACT

A fuel cell system including a fuel cell including a cell body having an electrolyte membrane held between a fuel electrode and an air electrode, and a fuel supply chamber neighboring to the fuel electrode of the cell body, and having a fuel liquid supply port (and optionally a fuel liquid collecting port); and a fuel liquid supply portion for supplying a fuel liquid into the fuel supply chamber through the fuel liquid supply port. The fuel liquid supply portion supplies the fuel liquid to the fuel supply chamber while generating positive and negative pressure variations in the fuel supply chamber and/or forward and reverse flows of the liquid in the fuel supply chamber for removing a gas produced on the fuel electrode side of the cell body.

### CROSS-REFERENCE TO RELATED APPLICATION

This application is based on Japanese patent application No.2004-379095 filed in Japan on Dec. 28, 2004, the entire content of which is hereby incorporated by reference.

### BACKGROUND OF THE INVENTION

1. Field of the Invention

The present invention relates to a fuel cell system including a fuel cell which includes a cell body having an electrolyte membrane held between an fuel electrode and an oxygen electrode as well as a fuel supply chamber neighboring to the fuel electrode of the cell body and having a fuel liquid supply port, and a fuel liquid supply portion provided for supplying a fuel liquid into the fuel supply chamber through its fuel liquid supply port. For example, the invention relates to the fuel cell system which utilizes a fuel cell such as a DMFC (Direct Methanol Fuel Cell) using a fuel liquid prepared by diluting a high-concentration fuel liquid with a diluent such as water.

2. Description of the Related Art

It has been increasingly required to increase lives of cells and batteries in accordance with start of a ubiquitous society. Conventional lithium cells have been developed to an extent close to a theoretical limit, and it is becoming difficult to expect significant improvement of performances. Under such circumstances, attention is being given to fuel cells which can have significantly increased life owing to its high energy density per weight (volume) as compared with conventional cells.

Among fuel cells, attention has been particularly given to Direct Methanol Fuel Cells (DMFCS), and research has been extensively conducted on such fuel cells because the DMFC has such features that (1) the structure is simple, (2) the fuel can be obtained without large-scale upgrading of infrastructure such as hydrogen stations and (3) it has an inexpensive structure operating at a low temperature, and therefore can be suitably used as fuel cells, e.g., for portable devices such as notebook-size computers, cellular phones, various personal digital assistants (PDAs) and others.

Fuel cell systems employing the DMFCs can be classified into two types according to the manner of fuel supply. One of the types is referred to as an active type, in which a pump is used for supplying fuel to the cell. The other type is referred to as a passive type, in which a pump is not used, and a capillary force or the like is used for supplying fuel.

Reaction formulas of the DMFC are as follows:

Reaction on fuel electrode (anode) side:
CH₃OH+H₂O→CO₂+6e⁻+6H⁺

Reaction on oxygen electrode (cathode) side;
(3/2)O₂+6H⁺+6e⁻→3H₂O

Overall reaction;
CH₃OH+(3/2)O₂→CO₂+2H₂O

According to the above reaction formulas, equimolar reaction occurs between methanol and water on the fuel electrode to produce CO₂ and six electrons and protons, and CO₂ is externally discharged. Electrons move to the oxygen electrode (air electrode) via an external circuit, and protons move through an electrolyte layer, which is another route, to the oxygen electrode (air electrode), and react with the electrons on the oxygen electrode to produce three molecules of water. From an overall reaction, CO₂ and two molecules of H₂O are produced.

The above DMFC has been disclosed, e.g., in Japanese Laid-Open Patent Publication No. 2003-132924 (JP2003-132924 A).

According to the above reaction formulas, the equimolar reaction occurs between the methanol and the water on the fuel electrode. However, a low-concentration aqueous methanol solution having a concentration from 3% to 5% is usually used as the fuel liquid which is actually supplied to the fuel electrode.

The purpose of this is to prevent a crossover phenomenon in which the methanol passes through the electrolyte membrane and moves to the oxygen electrode without causing the above reaction on the fuel electrode. The crossover phenomenon occurs more easily with increase in methanol concentration of the fuel. If the crossover phenomenon occurs, the reaction which must occur on the fuel electrode of the DMFC having the two electrodes (i.e., the fuel electrode and the oxygen electrode) also occurs on the oxygen electrode of the DMFC so that the fuel is wasted, and the cell efficiency remarkably lowers due to lowering of the potential on the oxygen electrode side. Accordingly, the low-concentration aqueous methanol solution diluted with water is usually used.

The fuel liquid supplied to the fuel cell employing the alcohol as its fuel is a low-concentration fuel liquid formed of a high-concentration fuel liquid diluted with a diluent. In this case, such a manner may be employed that a solution having an alcohol concentration, which is reduced in advance to a predetermined concentration by dilution, is stored in a fuel liquid container, and is supplied to the fuel cell by a pump. However, the fuel liquid must be continuously supplied during a power generating operation. Therefore, the fuel liquid is rapidly consumed so that the fuel liquid container must be frequently replaced with new one, or the fuel liquid must be frequently supplied to the container.

If the fuel liquid container has a larger capacity, replacement of the container or supply of the fuel liquid is required less frequently, but this is not suitable to portable fuel cell systems which are required to have small sizes.

In connection with this, Japanese Laid-Open Patent Publication No. 2004-152561 (JP2004-152561 A) has disclosed a manner in which water generating from an air electrode is collected, is mixed with a high-concentration alcohol to lower the alcohol concentration and is supplied to the fuel cell.

However, according to, e.g., the foregoing fuel cell system utilizing the DMFC, an electrochemical reaction generates a carbon dioxide gas on the fuel electrode side as already described. A part of the carbon dioxide gas dissolves into the fuel liquid, and moves toward the oxygen electrode (air electrode), but the other part remains on the fuel electrode side.

The carbon dioxide gas remaining on the fuel electrode side is discharged externally, e.g., through a vent, which allows passage of a gas without allowing passage of a liquid, and is formed at a wall of a fuel supply chamber (anode chamber) arranged close to the fuel electrode for supplying the fuel liquid to the fuel electrode. However, such discharging may not be performed smoothly.

For example, the carbon dioxide gas may adhere onto stepped portions or other concave portions in the anode chamber, a wall of the anode chamber, a surface of a catalyst layer of the fuel electrode and/or an inside of the catalyst layer, and may remain there. This remaining carbon dioxide gas cannot be naturally discharged without difficulty.

Gases such as air which have dissolved in the fuel liquid may deposit and remain on the surface of the catalyst layer. Also, by-products due to impurities in the fuel liquid or reaction may adhere onto the catalyst layer.

In the fuel cell such as a DMFC which generates a gas on a fuel electrode side due to an electrochemical reaction of the cell, if the gas is not externally discharged smoothly, the gas remaining therein is accumulated particularly in the catalyst region of the fuel electrode, and this accumulation lowers reaction efficiency and thus power generation efficiency. When the gas such as air dissolved in the fuel liquid is deposited and accumulated on the surface of the catalyst layer, and/or when the impurities in the fuel liquid and the by-products due to the reaction adhere onto the catalyst, a normal reaction is impeded, and this lowers the reaction efficiency and thus the power generation efficiency.

### SUMMARY OF THE INVENTION

Accordingly, it is an object of the invention to provide a fuel cell system including a fuel cell including a cell body having an electrolyte membrane held between a fuel electrode and an oxygen electrode and a fuel supply chamber neighboring to the fuel electrode of the cell body and having a fuel liquid supply port, and a fuel liquid supply portion for supplying a fuel liquid into the fuel supply chamber through the fuel liquid supply port of the fuel supply chamber, and particularly to provide a fuel cell system in which a gas generated on a fuel electrode side of the fuel cell can be removed smoothly from the fuel electrode side so that the supply of the fuel liquid to the fuel electrode and a reaction on the fuel electrode caused by the fuel liquid supply can be performed smoothly, and thereby power generation efficiency can be improved.

The invention provides a fuel cell system including:

a fuel cell including a cell body having an electrolyte membrane held between a fuel electrode and an oxygen electrode, and a fuel supply chamber neighboring to the fuel electrode of the cell body, and having a fuel liquid supply port (and optionally a fuel liquid collecting port); and

a fuel liquid supply portion for supplying a fuel liquid into the fuel supply chamber through the fuel liquid supply port of the fuel supply chamber.

For removing a gas produced On the fuel electrode side of the cell body, the fuel liquid is supplied into the fuel supply chamber from the fuel liquid supply portion while causing pressure variations in the fuel supply chamber and/or causing forward and reverse flows of the liquid in the fuel supply chamber (e.g., at least the pressure variations in the fuel supply chamber).

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows by way of example a fuel cell system according to the invention.

FIG. 2(A) is a cross section of an example of a micropump employed in the fuel cell system, FIG. 2(B) is a plan of the micropump, FIG. 2(C) illustrates by way of example a waveform of a drive signal for forward driving (positive driving) of the micropump and FIG. 2(D) illustrates by way of example the waveform of the drive signal for reversely driving the micropump.

FIG. 3 shows by way of example a manner of alternately feeding a high-concentration fuel liquid and a diluent by two micropumps, and supplying a diluted fuel liquid to the cell.

FIGS. 4(A), 4(B) and 4(C) are timing charts illustrating examples of system operations of the fuel cell system in FIG. 1.

FIG. 5 shows another example of the fuel cell system according to the invention.

FIGS. 6(A), 6(B) and 6(C) are timing charts illustrating examples of system operations of the fuel cell system in FIG. 5.

FIG. 7 shows still another example of the fuel cell system according to the invention.

FIGS. 8(A) and 8(B) are timing charts illustrating examples of system operations of the fuel cell system in FIG. 7.

FIG. 9 shows yet another example of the fuel cell system according to the invention.

FIGS. 10(A), 10(B) and 10(C) are timing charts illustrating examples of system operations of the fuel cell system in FIG. 9.

### DESCRIPTION OF THE PREFERRED EMBODIMENTS

A fuel cell system of a preferred embodiment of the invention basically has the following structure.

The fuel cell system includes:

a fuel cell including a cell body having an electrolyte membrane held between a fuel electrode and an oxygen electrode, and a fuel supply chamber neighboring to the fuel electrode of the cell body, and having a fuel liquid supply port (and optionally a fuel liquid collecting port); and

a fuel liquid supply portion for supplying a fuel liquid into the fuel supply chamber through the fuel liquid supply port of the fuel supply chamber, wherein

for removing a gas produced on the fuel electrode side of the cell body, the fuel liquid is supplied into the fuel supply chamber from the fuel liquid supply portion while causing pressure variations in the fuel supply chamber and/or causing forward and reverse flows of the liquid in the fuel supply chamber (e.g., at least the pressure variations in the fuel supply chamber).

According to this fuel cell system, when the pressure in the fuel supply chamber of the fuel cell is varied, the fuel liquid is supplied to the fuel supply chamber while causing pressure variations in the fuel supply chamber. In this case, a gas may be produced due to the electrochemical reaction of the cell on the fuel electrode side thereof. This gas may adhere onto a surface or an inner side of a catalyst layer of the fuel electrode, or onto a stepped portion or another concave portion in the fuel supply chamber or an inner wall of the fuel supply chamber, or such adhesion of the gas tends to occur. Even in these cases, the variations in pressure of the fuel supply chamber repetitively compress and expand bubbles of the gas to shake these bubbles so that the bubbles rapidly move away from the surface of the catalyst layer or the like, and can be smoothly discharged from the cell.

Likewise, when a gas such as air dissolved in the fuel liquid tends to be deposited on the catalyst layer or the like, or when impurities in the fuel liquid or by-products caused by a reaction tend to adhere onto the catalyst layer or the like, such gas, impurities and/or by-products undergo compression and expansion due to variations in pressure in the fuel supply chamber, and thereby are shaken so that these can be smoothly removed from the cell.

In the case where the fuel liquid is supplied into the fuel supply chamber while causing forward and reverse flows of the liquid in the fuel supply chamber, the gas produced on the fuel electrode side of the cell may adhere onto or may tend to adhere onto the surface or inside of the catalyst layer of the fuel electrode, or onto the stepped portion, concave portion or inner wall of the fuel supply chamber. Even in this case, the forward and reverse flows of the liquid in the fuel supply chamber shake the bubbles of the gas to promote separation of the bubbles from the above portions so that the gas can be smoothly removed from the cell.

Likewise, when a gas such as air dissolved in the fuel liquid tends to be deposited on the catalyst layer or the like, or when impurities in the fuel liquid or by-products caused by a reaction tend to adhere onto the catalyst layer or the like, such gas, impurities and/or by-products are shaken by the forward and reverse flows of the liquid in the fuel supply chamber so that these can be smoothly removed from the cell.

The “forward and reverse flows” are a “forward flow” and a “reverse flow” with respect to the “forward flow”. More specifically, the “forward flow” is a flow of the liquid formed in the forward direction when supplying the fuel liquid to the fuel supply chamber from the fuel liquid supply portion. The “reverse flow” is a flow of the liquid in the direction opposite to the “forward flow”.

The supply of the fuel liquid to the fuel supply chamber may be performed to cause the variations in pressure of the fuel supply chamber and also to produce the forward and reverse flows of the liquid in the fuel supply chamber for removing the gas produced on the fuel electrode side of the cell body. Thereby, the bubbles or the like are shaken more effectively, and therefore can be removed more smoothly from the cell,

The pressure variations in the fuel supply chamber may be positive and negative pressure variations caused by repetition of the positive and negative pressures, or may be positive pressure variations or negative pressure variations caused by repetitive variations in magnitude of the positive pressure or the negative pressure.

The “positive pressure” and the “negative pressure” are pressures which are positive and negative with respect to the atmospheric pressure, respectively.

The pressure variations as well as the forward and reverse flows of the liquid are cyclically repeated according to predetermined timing so that the supply of the fuel liquid, which does not impede the power generation of the fuel cell, can be ensured.

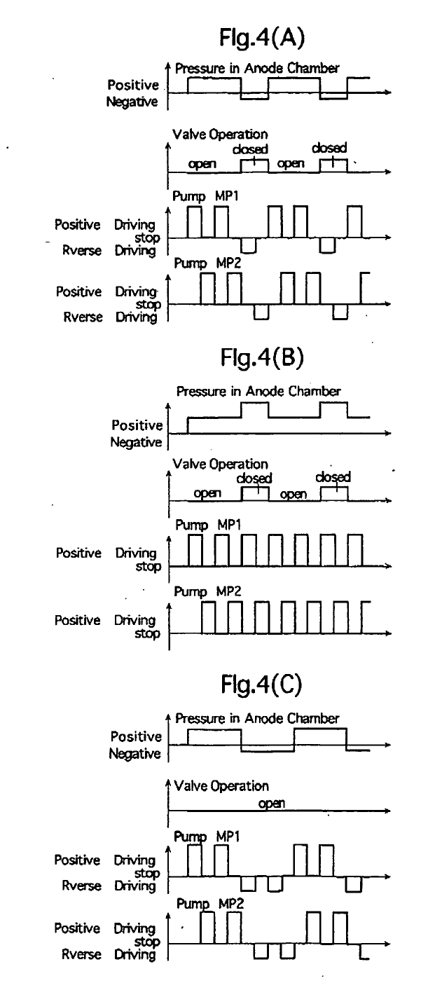

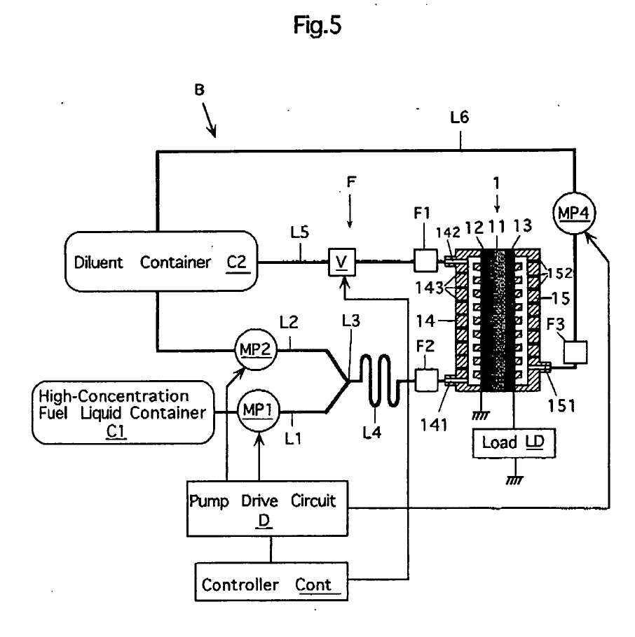

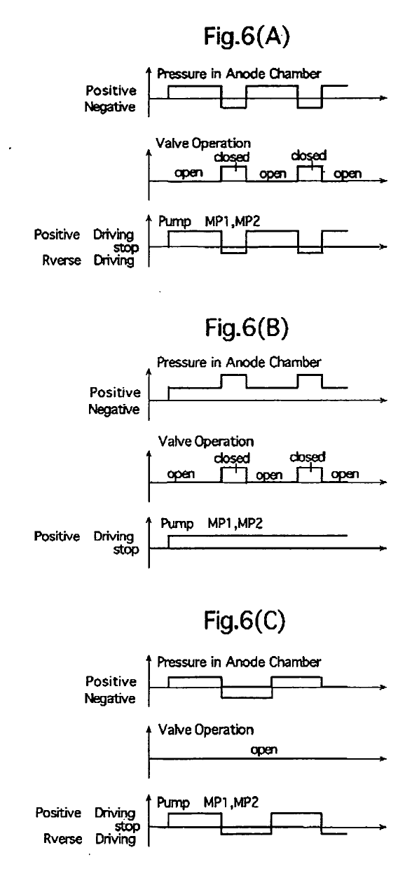

Specific examples of the fuel cell system according to the invention will now be described.

<First Fuel Cell System (Embodiments in FIGS. 4(A) and 6(A) Relate to This)>

A fuel cell system including a fuel cell including a cell body having an electrolyte membrane held between a fuel electrode and an oxygen electrode, and a fuel supply chamber neighboring to the fuel electrode of the cell body, and having a fuel liquid supply port and a fuel liquid collecting port;

a fuel liquid supply portion including a reversely operable feed pump supplying a fuel liquid into the fuel supply chamber through the fuel liquid supply port of the fuel supply chamber;

a valve connected to the fuel liquid collecting port for controlling a flow rate; and

a control portion for the feed pump of the fuel liquid supply portion and the valve, wherein the control portion controls an operation of the feed pump of the fuel liquid supply portion and the flow rate of the valve such that the fuel liquid supply portion cooperates with the valve to supply the fuel liquid to the fuel supply chamber while generating positive and negative pressure variations and forward and reverse flows of the liquid in the fuel supply chamber for removing a gas produced on the fuel electrode side of the cell body.

21 Second Fuel Cell System (Embodiments in FIGS. 4(B) and 6(B) Relate to This)>

A fuel cell system including a fuel cell including a cell body having an electrolyte membrane held between a fuel electrode and an oxygen electrode, and a fuel supply chamber neighboring to the fuel electrode of the cell body, and having a fuel liquid supply port and a fuel liquid collecting port;

a fuel liquid supply portion including a feed pump supplying a fuel liquid into the fuel supply chamber through the fuel liquid supply port of the fuel supply chamber;

a valve connected to the fuel liquid collecting port for controlling a flow rate; and

a control portion for the feed pump of the fuel liquid supply portion and the valve, wherein

the control portion controls an operation of the feed pump of the fuel liquid supply portion and the flow rate of the valve such that the fuel liquid supply portion cooperates with the valve to supply the fuel liquid to the fuel supply chamber while generating positive pressure variations in the fuel supply chamber for removing a gas produced on the fuel electrode side of the cell body.

<Third Fuel Cell System (Embodiments in FIGS. 4(C) and 6(C) Relate to This)>

A fuel cell system including a fuel cell including a cell body having an electrolyte membrane held between a fuel electrode and an oxygen electrode, and a fuel supply chamber neighboring to the fuel electrode of the cell body, and having a fuel liquid supply port;

a fuel liquid supply portion including a reversely operable feed pump supplying a fuel liquid into the fuel supply chamber through the fuel liquid supply port of the fuel supply chamber; and

a control portion for the feed pump of the fuel liquid supply portion, wherein

the control portion controls an operation of the feed pump of the fuel liquid supply portion such that the fuel liquid supply portion supplies the fuel liquid to the fuel supply chamber while generating positive and negative pressure variations and forward and reverse flows of the liquid in the fuel supply chamber for removing a gas produced on the fuel electrode side of the cell body.

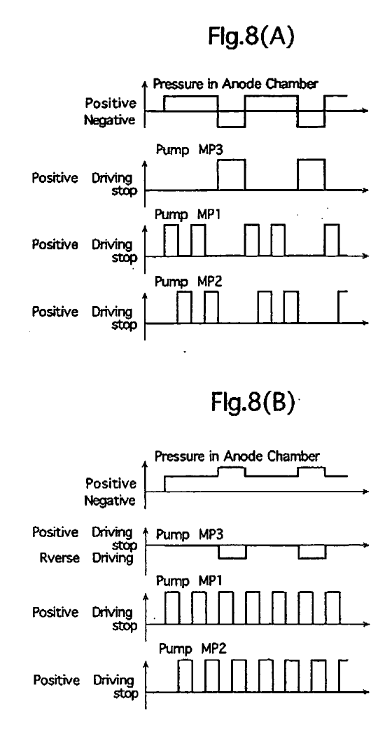

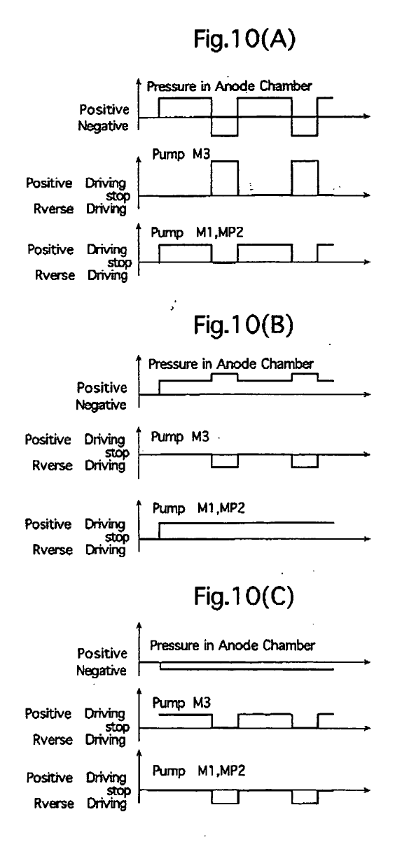

The fuel supply chamber of the cell in this system may include a fuel liquid collecting port.

<Fourth Fuel Cell System (Embodiments in FIGS. 8(A) and 10(A) Relate to This)>

A fuel cell system including a fuel cell including a cell body having an electrolyte membrane held between a fuel electrode and an oxygen electrode, and a fuel supply chamber neighboring to the fuel electrode of the cell body, and having a fuel liquid supply port and a fuel liquid collecting port;

a fuel liquid supply portion including a feed pump supplying a fuel liquid into the fuel supply chamber through the fuel liquid supply port of the fuel supply chamber;

a collecting pump connected to the fuel liquid collecting port; and

a control portion for the feed pump of the fuel liquid supply portion and the collecting pump, wherein the control portion controls operations of the feed pump of the fuel liquid supply portion and the collecting pump such that the fuel liquid supply portion cooperates with the collecting pump to supply the fuel liquid to the fuel supply chamber while generating positive and negative pressure variations in the fuel supply chamber for removing a gas produced on the fuel electrode side of the cell body.

<Fifth Fuel Cell System (Embodiments in FIGS. 8(B) and 10(B) Relate to This)>

A fuel cell system including a fuel cell including a cell body having an electrolyte membrane held between a fuel electrode and an oxygen electrode, and a fuel supply chamber neighboring to the fuel electrode of the cell body, and having a fuel liquid supply port and a fuel liquid collecting port;

a fuel liquid supply portion including a feed pump supplying a fuel liquid into the fuel supply chamber through the fuel liquid supply port of the fuel supply chamber;

a collecting pump connected to the fuel liquid collecting port; and

a control portion for the feed pump of the fuel liquid supply portion and the collecting pump, wherein the control portion controls operations of the feed pump of the fuel liquid supply portion and the collecting pump such that the fuel liquid supply portion cooperates with the collecting pump to supply the fuel liquid to the fuel supply chamber while generating positive pressure variations in the fuel supply chamber for removing a gas produced on the fuel electrode side of the cell body.

According to this fifth fuel cell system, the control portion may be configured to control the operations of the feed pump of the liquid supply portion and the collecting pump so that the fuel liquid may be supplied to the fuel supply chamber while generating negative pressure variations, instead of generating the positive pressure variations in the fuel supply chamber, for removing the gas produced on the fuel electrode side of the cell body.

<Sixth Fuel Cell System (Embodiment in FIG. 10(C) Relates to This)>

In addition to the above systems, the following fuel cell system can achieve the object of the invention.

A fuel cell system including a fuel cell including a cell body having an electrolyte membrane held between a fuel electrode and an oxygen electrode, and a fuel supply chamber neighboring to the fuel electrode of the cell body, and having a fuel liquid supply port and a fuel liquid collecting port;

a fuel liquid supply portion including a feed pump supplying a fuel liquid into the fuel supply chamber through the fuel liquid supply port of the fuel supply chamber;

a collecting pump connected to the fuel liquid collecting port; and

a control portion for the feed pump of the fuel liquid supply portion and the collecting pump, wherein the control portion controls operations of the feed pump of the fuel liquid supply portion and the collecting pump to cause intermittently forward and reverse flows of the liquid in the fuel supply chamber while maintaining a negative pressure in the fuel supply chamber for removing a gas produced on the fuel electrode side of the cell body.

According to this sixth fuel cell system, the control portion may be configured to control the operations of the feed pump of the liquid supply portion and the collecting pump so as to cause intermittently the forward and reverse flows of the liquid in the fuel supply chamber while maintaining a positive pressure in the fuel supply chamber, instead of maintaining the negative pressure, for removing a gas produced on the fuel electrode side of the cell body.

In the fuel cell system generating the pressure variations, which are the positive and negative pressure variations achieved by repeating the positive and negative pressures, in the fuel supply chamber, it is preferable that the maximum value of the absolute value of the negative pressure in the fuel supply chamber is 1/10 or more of an average value of the positive pressure in the fuel supply chamber in view of-discharging the produced gas by temporarily causing a negative pressure on the catalyst layer on the fuel electrode side. The upper limit of the maximum value is substantially determined not to exceed the average value of the positive pressure in view of preventing the impeding of the fuel supply.

In the fuel cell system generating the pressure variations, which-are the positive pressure variations achieved by repeating the variations in magnitude of the positive pressure, in the fuel supply chamber, the positive pressure variations in the fuel supply chamber may be configured to cause a pressure larger than the average pressure in the fuel supply chamber. In this case, in view of the supply of the fuel liquid to the fuel supply chamber and the removal of the gas produced on the fuel electrode side, a total time length of a period for which the pressure in the fuel supply chamber is larger than the average pressure is approximately in a range from ½ to 1/10 of a drive time of the fuel cell, and the pressure larger than the average pressure may include a pressure larger by 1.05 to 2 times than the average pressure.

In any one of the above structures of the fuel cell system according to the invention, the fuel liquid diluted in advance to a predetermined concentration may be supplied from the fuel liquid supply portion to the fuel supply chamber, in which case only the pump for the diluted fuel liquid may be employed as the feed pump in the fuel liquid supply portion. Alternatively, the system may utilize the fuel cell using the fuel liquid prepared by diluting a high-concentration fuel liquid with a diluent.

In the latter case, the fuel liquid supply portion may have a first pump for the high-concentration fuel liquid and a second pump for the diluent, and also may have a mixing passage for mixing the high-concentration fuel liquid provided from the first pump with the diluent provided from the second pump, and leading them to the fuel liquid supply port of the fuel supply chamber of the fuel cell.

In any one of the above structures, a liquid-gas separator separating and discharging a gas from the liquid reversely flowing from the fuel liquid supply port toward the fuel liquid supply portion may be connected between the fuel liquid supply portion and the fuel liquid supply port of the fuel supply chamber of the fuel cell.

In the first and second fuel cell systems, a liquid-gas separator separating and discharging a gas from the liquid flowing from the fuel liquid collecting port toward the valve may be connected between the valve and the fuel liquid collecting port of the fuel supply chamber of the fuel cell.

The third fuel cell system may be provided at the fuel supply chamber with a fuel liquid collecting port, in which case the fuel liquid collecting port may be connected to a liquid-gas separator separating and discharging a gas from the liquid flowing from the fuel liquid collecting port.

In the fourth to sixth fuel cell systems, a liquid-gas separator separating and discharging a gas from the liquid flowing from the fuel liquid collecting port toward the collecting pump may be connected between the collecting pump and the fuel liquid collecting port of the fuel supply chamber of the fuel cell.

In any one of the fuel cell systems, the fuel cell may be typically a DMFC. In this case, the “high-concentration fuel liquid” may be methanol or high-concentration aqueous methanol solution, and the diluent may be water or liquid containing water as a major component. Water produced on a cathode (air electrode or oxygen electrode) side of the DMFC may be used as the diluent.

It is recommended to use a micropump as each of the foregoing pumps for achieving a compact structure of the system, but this is not restrictive.

The micropump may be integral with the fuel cell for achieving the compact structure of the system.

For example, the micropump may include a first choke passages a second choke passage shorter than the first choke passage, a pump chamber between the first and second choke passages, a diaphragm opposed to the pump chamber and capable of changing a capacity of the pump chamber, and a drive actuator arranged on the diaphragm.

In such micropump, a pulse voltage is applied to the drive actuator to draw the liquid from the first (or second) choke passage into the pump chamber and the liquid is discharged through the second (or first) choke passage from the pump chamber in accordance with a waveform of the pulse voltage.

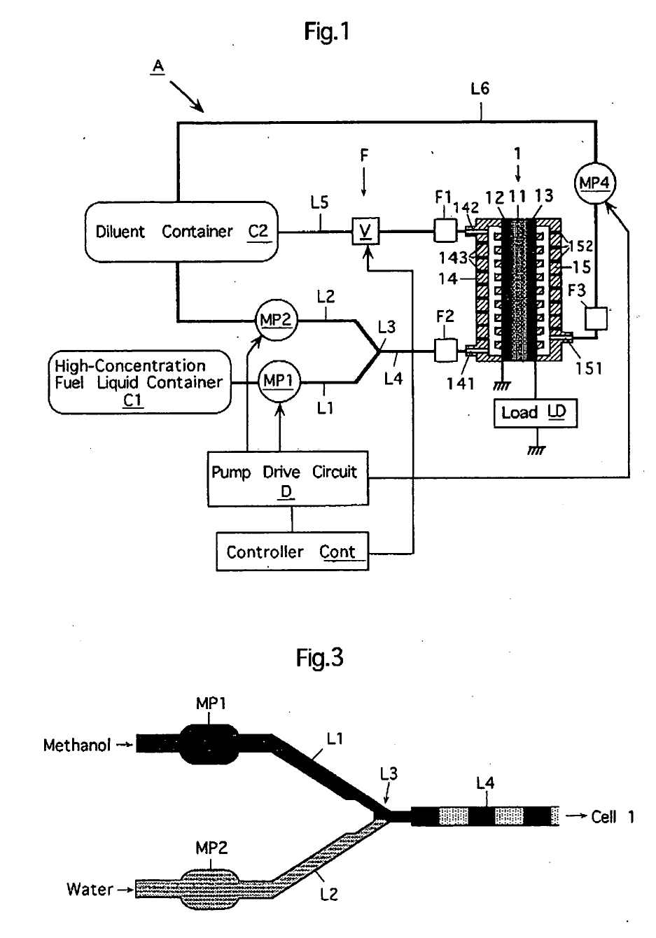

Several examples of the fuel cell system will now be described with reference to the drawings.

<Fuel Cell System Shown in FIG. 1 and Embodiments 1-3 Based on the Same>

### (1) Fuel Cell System in FIG. 1

Prior to the description of the embodiments 1 to 3, a fuel cell system of a structure shown in FIG. 1 will now be described.

A fuel cell system A in FIG. 1 employs a Direct Methanol Fuel Cell (DMFC) 1 as a fuel cell, and a fuel liquid supply portion F supplies a fuel liquid to the cell 1 to generate an electric power.

The cell 1 has a MEA (Membrane Electrode Assembly) structure in which an anode (fuel electrode) 12 and a cathode (air electrode, i.e., oxygen electrode) 13 are joined to the opposite surfaces of an electrolyte membrane 11. A separator is fixed to the anode 12 to form an anode chamber (fuel supply chamber) 14, and a separator is fixed to the cathode 13 to form a cathode chamber (liquid collecting chamber) 15.

In this example, the anode 12 is formed of a catalyst layer (made of e.g., platinum black or platinum alloy carried by carbon black) in contact with the electrolyte membrane 11 as well as an electrode, e.g., of a carbon paper layered on the catalyst layer. The cathode 13 is formed of a similar catalyst layer in contact with the electrolyte membrane 11 and a similar electrode layered thereon.

The anode chamber 14 has a fuel liquid supply port 141 and a fuel liquid collecting port 142. The anode chamber 14 has a liquid passage for dispersing and supplying the fuel liquid, which is supplied from a fuel liquid supply portion F to the fuel liquid supply port 141, to a whole area of the anode 12.

The anode chamber 14 is further provided at its wall with vents 143 for externally discharging a carbon dioxide gas which is generated on the anode 12 side by an electrochemical reaction of the cell 1. The vents 143 allow passing of the gas from the chamber to the outside, but prevents the passing of the liquid from the chamber to the outside. For this purpose, the vents 143 are formed of minute apertures, and are processed to have water repellency. However, the vents 143 are not essential.

A liquid (water) is produced on the cathode side by the electrochemical reaction, and a liquid may move from the anode side through the electrolyte membrane 11 toward the cathode. The cathode chamber 15 is provided with a liquid passage for collecting these liquids from the whole area of the cathode 13 as well as a liquid outlet 151 for discharging the liquid from the liquid passage. The cathode chamber 15 is further provided with vents 152 for taking in an external air (oxygen) and supplying it to the cathode 13. The vents 152 allow passing of the air into the chamber from the outside, but prevents passing of the liquid from the chamber to the outside. For this purpose, the vents 152 are formed of minute apertures, and are processed to have water repellency.

The fuel liquid supply portion F includes a high-concentration fuel liquid supply passage L1 connected to a container C1 containing a high-concentration fuel liquid (methanol at about 100% in this example), and also includes a diluent supply passage L2 connected to a container C2 containing a diluent (water or liquid primarily containing water in this example).

The high-concentration fuel liquid supply passage L1 is provided at its some midpoint with a pump MP1 for feeding the high-concentration fuel liquid from the container C1, and the diluent supply passage L2 is provided at its some midpoint with a pump MP2 for feeding the diluent from the container C2.

The supply passages L1 and L2 join together at a confluence L3, and a mixture passage L4 extends from the confluence L3 to the fuel liquid supply port 141 of the anode chamber 14. The mixture passage L4 is connected to the fuel liquid supply port 141 of the anode chamber 14 via a liquid-gas separator F2.

The liquid-gas separator F2 prevents entry of the gas generated on the anode side into the mixture passage L4 through the fuel liquid supply port 141, and separates the gas for externally discharging it.

The fuel liquid collecting port 142 of the fuel supply chamber 14 of the cell is communicated with the diluent container C2 via a collecting passage L5. The collecting passage L5 is provided for leading to the container C2 the liquid such as a surplus fuel liquid that was used on the anode side and thereby has a low methanol concentration. In this example, the collecting passage L5 is provided at its some midpoint with an electromagnetic on-off valve V serving as a valve that can control the flow rate.

A liquid-gas separator F1 is connected between the fuel liquid collecting port 142 and the diluent container C2 for separating and externally discharging the gas from the liquid flowing from the fuel liquid collecting port 142.

The liquid outlet 151 of the cathode chamber 15 of the fuel cell 1 is connected to the diluent container C2 via a liquid-gas separator F3 and a liquid collecting passage L6, and a pump MP4 is arranged at some midpoint thereof. The liquid-gas separator F3 is employed for separating and discharging the gas from the liquid flowing from the liquid outlet 151.

Each of the liquid-gas separators F1, F2 and F3 may have any structure provided that it can separate and externally discharge the gas. For example, the liquid-gas separators F1, F2 and F3 may have structures utilizing well-known liquid-gas separating membranes.

The fuel cell system A in FIG. 1 further includes a drive circuit D for pumps MP1, MP2 and MP4 as well as a controller Cont controlling the pump drive circuit D.

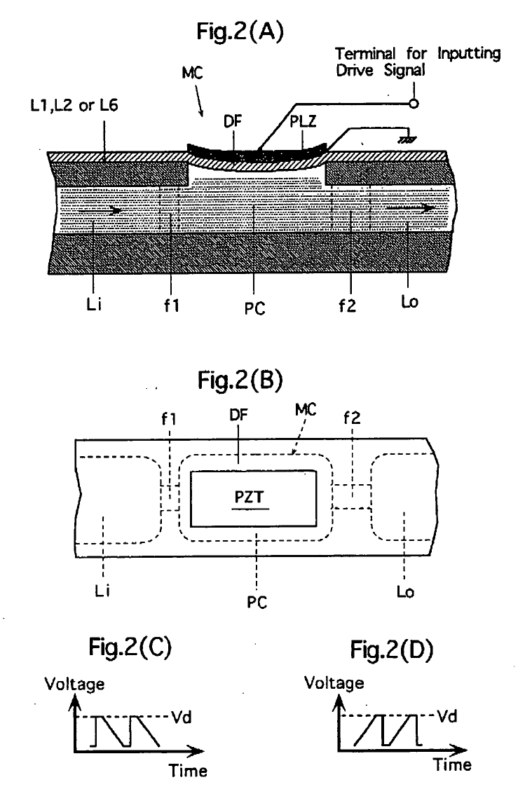

The pumps MP1 and MP2 in the fuel liquid supply portion F as well as the pump MP4 on the cathode side may have any kind of structures provided that these can feed the liquid. In this example, these pumps MP1, MP2 and MP4 are formed of micropumps (indicated by “MC” in FIGS. 2(A) and 2(B)) which have basic structures shown in FIGS. 2(A) and 2(B), and perform the liquid feeding operation in response to application of a drive waveform signal shown in FIGS. 2(C) or 2(D).

First, the structure of the micropump MC will now be described. The micropump MC includes a pump chamber PC arranged in the liquid passage L1, L2 or L6, a restriction passage (choke passage) f1 formed between an upper liquid passage portion L1 and the pump chamber PC, a restriction passage (choke passage) f2 formed between a lower liquid passage portion Lo and the pump chamber PC, a diaphragm DF opposed to the pump chamber PC and a piezoelectric element PZT which is an example of an actuator attached to the diaphragm DF. The restriction passages f1 and f2 have substantially the same sectional areas, but the passage f2 is longer than the passage f1.

The pump MC operates as follows. A pulse voltage is applied to the piezoelectric element PZT to vibrate the pump chamber wall (diaphragm) DF so that the pump chamber PC expands and contracts according to the applied pulse voltage waveform. Thereby, the liquid can be taken into the pump chamber PC from the first restriction passage f1 (or second restriction passage f2), and can be discharged from pump chamber PC through the second restriction passage f2 (or first restriction passage f1).

More specifically, the pulse voltage which is provided from the drive circuit D for driving the. piezoelectric element PZT may have a pulse voltage waveform exhibiting rapid rising and slow falling as shown in FIG. 2(C). Thereby, the piezoelectric element rapidly deforms the diaphragm DF to contract rapidly the pump chamber PC in response to the rapid rising of the applied voltage. Thereby, the liquid flowing in the long passage f2 form a lamilar flow owing to the passage resistance. However, the liquid in the short passage f1 form a turbulent flow so that the flow of the liquid from the passage f1 is suppressed. Thereby, the liquid in the pump chamber can be discharged from the passage f2.

When the applied voltage slowly lowers, the piezoelectric element slowly returns the diaphragm DF to expand slowly the pump chamber PC. Thereby, the liquid flows from the short passage f1 into the pump chamber PC, and at the same time, the discharging of the liquid from the long passage f2 having a larger passage resistance than the passage f1 is suppressed. Thereby, the liquid can be taken into the pump chamber PC from the passage f1.

The pumps MP1, MP2 and MP3 have the basic structures described above, and feed the liquid on the above operation principle.

Accordingly, in the fuel cell system A in FIG. 1, each of the pumps MP1 and MP2 is configured such that the passage f1 is arranged on the upstream side (container C1 or C2 side), and the passage f2 is arranged on the downstream side (cell 1 side). Thereby, the pumps MP1 and MP2 are alternately or simultaneously driven to supply the diluted fuel liquid into the anode chamber 14 of the cell 1 by flowing it in a forward direction (forward flow).

The pump MP4 is likewise configured such that the passage f1 is arranged on the upstream side (cell 1 side), and the passage f2 is arranged on the downstream side (container C2 side). Thereby, the pump MP4 can be driven to collect the liquid from the cathode chamber 15 of the cell into the container C2.

FIG. 3 shows by way of example a manner of alternately driving micropumps MP1 and MP2 to feed alternately the high-concentration fuel liquid and the diluent to the mixture passage L4. The high-concentration fuel liquid and the diluent thus fed alternately are diffused and mixed together to form the diluted fuel liquid while they flow through the mixture passage. Thus, the diluted liquid fuel is supplied to the anode chamber 14.

Also, by simultaneously driving micropumps MP1 and MP2 to feed simultaneously the high-concentration fuel liquid and the diluent into the mixture passage L4, these liquids can be mixed together during flowing through the mixture passage so that the diluted fuel liquid is obtained.

When the drive circuit D applies the pulse voltage which slowly rises and rapidly falls as shown in FIG. 2(D), the liquid can be taken from the passage f2 into the pump chamber PC, and the liquid in the pump chamber can be discharged through the passage f1. In this manner, each of the pumps MP1 and MP2 can be driven to generate a reverse flow so that a reverse flow can be produced in the anode chamber 14 when necessary.

The micropump may be integral with the anode chamber 14 and the cathode chamber 15 for achieving a compact structure of the system.

According to this fuel cell system A, the pump drive circuit D applies the drive signal to the piezoelectric element of each pump in response to the instruction by the controller Cont, and thereby the pump MP1 feeds the high-concentration fuel liquid from the container C1 to the confluence L3. Also, the pump MP2 feeds the diluent from container C2 to the confluence L3. These liquids are mixed in the mixture passage L4, and the diluted fuel liquid (e.g., about 3% aqueous methanol solution) thus obtained is supplied to the fuel cell 1 for power generation, and the power can be supplied to a load LD.

The water produced on the cathode 13 side by the electrochemical reaction in the fuel cell 1 and the liquid which may pass from the anode 12 side through the electrolyte membrane 11 toward the cathode 13 side are collected from the cathode chamber 15 into the container C2 by the operation of the pump MP4. Before the first use of the fuel cell system, the container C2 is filled with the water.

### (2) Embodiments 1-3

The fuel cell system A shown in FIG. 1 can basically generate the power as described above. For smoothly removing the carbon dioxide gas generated on the anode (fuel electrode) 12 side by the electrochemical reaction in the cell 1, impurities in the fuel, by-products caused by the reaction and others, and thereby improving the generation efficiency, the pumps MP1 and MP2 and the valve V operate in one of the manners in the following embodiments 1-3, and the controller Cont controls the pump drive circuit D and the opening/closing of the electromagnetic on-off valve V for performing the operations in the embodiments 1-3. In the embodiments 1-3, the fuel liquid supply is performed by alternately driving the pumps MP1 and MP2.

### (2-1) Embodiment 1 (see FIG. 4(A))

As shown in FIG. 4(A), the pumps MP1 and MP2 are alternately driven by the drive signal of the waveform in FIG. 2(C), and thereby are alternately and positively driven while the valve V is kept open. Thereby, the high-concentration fuel liquid and the diluent are alternately fed, and are mixed together in the mixture passage L4, and the mixture liquid is fed to the anode chamber 14 of the cell 1. Thereby, the pressure in the anode chamber 14 rises, and the fuel liquid is supplied to the anode (fuel electrode) 12.

Then, the valve V is closed, and the pumps MP1 and MP2 are alternately driven according to the drive signal of the waveform in FIG. 2(D), and are alternately and reversely driven so that the liquid in the anode chamber 14 is reversely fed to reduce the pressure in the anode chamber 14 (i.e., to attain the negative pressure).

The above operations are repeated.

In this manner, the carbon dioxide gas expands and contracts. Also, the carbon dioxide gas is exposed to the forward and reverse flows of the liquid. These operations further facilitate the movement and discharge of the carbon dioxide gas from the vents 143.

The liquid-gas separator F1 removes the carbon dioxide gas mixed into the liquid flowing from-the fuel liquid collecting port 142, and the liquid-gas separator F2 removes the carbon dioxide gas mixed into the liquid which may reversely flow from the fuel liquid supply port 141. The impurities in the fuel liquid and the by-products produced by the reaction become easy to move, and are smoothly discharged from the anode chamber.

As described above, the fuel liquid is supplied while efficiently discharging the carbon dioxide gas.

### (2-2) Embodiment 2 (see FIG. 4(B))

As shown in FIG. 4(B), the pumps MP1 and MP2 are alternately driven by the drive signal of the waveform in FIG. 2(C), and thereby are alternately and positively driven while the valve V is kept open. Thereby, the high-concentration fuel liquid and the diluent are alternately fed, and are mixed together in the mixture passage L4, and the mixture liquid is fed to the anode chamber 14 of the cell 1.

Thereby, the pressure in the anode chamber 14 rises, and the fuel liquid is supplied to the anode (fuel electrode) 12. Then, the valve V is closed, and the pumps MP1 and MP2 continue the positive driving so that the pressure in the anode chamber rises, and the pressurized fuel liquid is supplied.

By repeating the above operations, the fuel liquid in the anode chamber 14 is exchanged, and the fuel supply pressure is intermittently raised so that the carbon dioxide gas is compressed and expanded.

This facilitates movement of the carbon dioxide gas, and the carbon dioxide gas is discharged from the vents 143. The liquid-gas separator F1 removes the carbon dioxide gas mixed into the liquid flowing from liquid collecting port 142, and the liquid-gas separator F2 removes the carbon dioxide gas mixed in the liquid which may flow reversely from the fuel liquid supply port 141.

The impurities in the fuel liquid and the by-products caused by the reaction become easy to move, and thus are smoothly discharged from the anode chamber.

As described above, the fuel liquid is supplied while efficiently discharging the carbon dioxide gas.

### (2-3) Embodiment 3 (see FIG. 4(C))

As shown in FIG. 4(C), the pumps MP1 and MP2 are alternately driven by the drive signal of the waveform in FIG. 2(C), and thereby are alternately and positively driven while the valve V is kept open. Thereby, the high-concentration fuel liquid and the diluent are alternately fed, and are mixed together in the mixture passage L4, and the mixture liquid is fed to the anode chamber 14 of the cell 1.

Thereby, the pressure in the anode chamber 14 rises, and the fuel liquid is supplied to the anode (fuel electrode) 12. Then, the pumps MP1 and MP2 are alternately driven by the drive signal of the waveform in FIG. 2(D), and thereby are alternately and reversely driven while the valve v is kept open.

Thereby, the pressure in the anode chamber 14 is reduced to attain the negative pressure, and at the same time the liquid is reversely fed. The above operations are repeated.

In this manner, the carbon dioxide gas expands and contracts. Also, the carbon dioxide gas is exposed to the forward and reverse flows of the liquid. These operations further facilitate the movement and discharge of the carbon dioxide gas from the vents 143. The liquid-gas separator F1 removes the carbon dioxide gas mixed into the liquid flowing from the fuel liquid collecting port 142, and the liquid-gas separator F2 removes the carbon dioxide gas mixed into the liquid which may flow from the fuel liquid supply port 141.

The impurities in the fuel liquid and the by-products produced by the reaction become easy to move, and are smoothly discharged from the anode chamber.

As described above, the fuel liquid is supplied while efficiently discharging the carbon dioxide gas.

<Fuel Cell System Shown in FIG. 5 and Embodiments 4-6 Based on It>

(1) Fuel Cell System in FIG. 5

A fuel bell system B of a structure shown in FIG. 5 differs from the fuel cell system A shown in FIG. 1 in that the fuel liquid is supplied to the cell 1 by simultaneously driving the pumps MP1 and MP2, and the mixture passage L4 has a meandering and thus long form for ensuring the mixing of the high-concentration fuel liquid and the diluent. Structures and manners other than the above are the same as those in the system A shown in FIG. 1. The parts and portions which are the same or substantially the same as those in the system A bear the same reference numbers or symbols.

### (2) Embodiments 4-6

In this fuel cell system B, for smoothly removing the carbon dioxide gas generated on the anode (fuel electrode) 12 side by the electrochemical reaction in the cell 1, and thereby improving the power generation efficiency, the pumps MP1 and MP2 and the valve V operate in any one of manners in the embodiments 4-6, and the controller Cont controls the pump drive circuit D and the opening/closing of the electromagnetic on-off valve V for achieving the operations in the above manners.

### (2-1) Embodiment 4 (see FIG. 6(A))

As shown in FIG. 6(A), the pumps MP1 and MP2 are simultaneously driven by the drive signal of the waveform in FIG. 2(C), and thereby are positively driven while the valve V is kept open. Thereby, the high-concentration fuel liquid and the diluent-are simultaneously fed, and are mixed together in the mixture passage L4, and the mixture liquid is fed to the anode chamber 14 of the cell 1. Thereby, the pressure in the anode chamber 14 rises, and the fuel liquid is supplied to the anode (fuel electrode) 12.

Then, the valve V is closed, and the pumps MP1 and MP2 are simultaneously driven by the drive signal of the waveform in FIG. 2(D), and thereby are reversely driven. Thereby, the liquid in the anode chamber 14 is reversely fed, and the pressure in the anode chamber 14 is reduced to attain the negative pressure. The above operations are repeated.

In this manner, the carbon dioxide gas expands and contracts. Also, the carbon dioxide gas is exposed to the forward and reverse flows of the liquid. These operations further facilitate the movement and discharge of the carbon dioxide gas from the vents 143.

The liquid-gas separator F1 removes the carbon dioxide gas mixed into the liquid flowing from the fuel liquid collecting port 142, and the liquid-gas separator F2 removes the carbon dioxide gas mixed into the liquid which may reversely flow from the fuel liquid supply port 141. The impurities in the fuel liquid and the by-products produced by the reaction become easy to move, and are smoothly discharged from the anode chamber.

As described above, the fuel liquid is supplied while efficiently discharging the carbon dioxide gas.

### (2-2) Embodiment 5 (see FIG. 6(B))

As shown in FIG. 6(B), the pumps MP1 and MP2 are simultaneously driven by the drive signal of the waveform in FIG. 2(C), and thereby are positively driven while the valve v is kept open. Thereby, the high-concentration fuel liquid and the diluent are simultaneously fed, and are mixed together in the mixture passage L4, and the mixture liquid is fed to the anode chamber 14 of the cell 1. Thereby, the pressure in the anode chamber 14 rises, and the fuel liquid is supplied to the anode (fuel electrode) 12.

Then, the valve V is closed, and the pumps MP1 and MP2 continue the positive operations so that the pressure in the anode chamber rises, and the pressurized fuel liquid is supplied.

By repeating the above operations, the fuel liquid in the anode chamber 14 is exchanged, and the fuel supply pressure is intermittently raised so that the carbon dioxide gas is compressed and expanded. This facilitates movement of the carbon dioxide gas, and the carbon dioxide gas is discharged from the vents 143.

The liquid-gas separator F1 removes the carbon dioxide gas mixed into the liquid flowing from liquid collecting port 142, and the liquid-gas separator F2 removes the carbon dioxide gas mixed in the liquid which may flow from the fuel liquid supply port 141.

The impurities in the fuel liquid and the by-products caused by the reaction become easy to move, and thus are smoothly discharged from the anode chamber.

As described above, the fuel liquid is supplied while efficiently discharging the carbon dioxide gas.

### (2-3) Embodiment 6 (see FIG. 6(C))

As shown in FIG. 6(C), the pumps MP1 and MP2 are simultaneously driven by the drive signal of the waveform in FIG. 2(C), and thereby are positively driven while the valve v is kept open. Thereby, the high-concentration fuel liquid and the diluent are simultaneously fed, and are mixed together in the mixture passage L4, and the mixture liquid is fed to the anode chamber 14 of the cell 1.

Thereby, the pressure in the anode chamber 14 rises, and the fuel liquid is supplied to the anode (fuel electrode) 12. Then, the pumps MP1 and MP2 are simultaneously driven by the drive signal of the waveform in FIG. 2(D), and thereby are reversely driven while the valve v is kept open.

Thereby, the pressure in the anode chamber 14 is reduced to attain the negative pressure, and at the same time the liquid is reversely fed. The above operations are repeated.

In this manner, the carbon dioxide gas expands and contracts. Also, the carbon dioxide gas is exposed to the forward and reverse flows of the liquid. These operations further facilitate the movement and discharge of the carbon dioxide gas from the vents 143.

The liquid-gas separator F1 removes the carbon dioxide gas mixed into the liquid flowing from the fuel liquid collecting port 142, and the liquid-gas separator F2 removes the carbon dioxide gas mixed into the liquid which may flow from the fuel liquid supply port 141.

The impurities in the fuel liquid and the by-products produced by the reaction become easy to move, and are smoothly discharged from the anode chamber.

As described above, the fuel liquid is supplied while efficiently discharging the carbon dioxide gas.

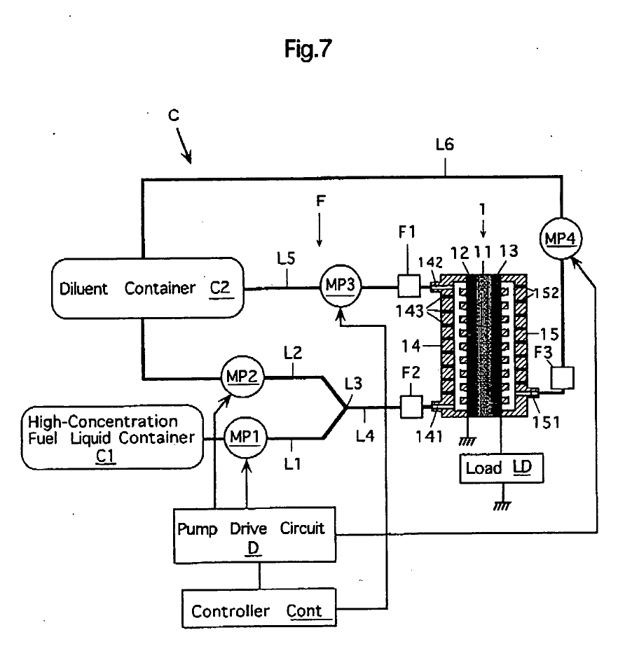

### Fuel Cell System Shown in FIG. 7 and Embodiments 7 and 8 Based on It

### (1) Fuel Cell System in FIG. 7

A fuel cell system C of a structure shown in FIG. 7 differs from the fuel cell system A shown in FIG. 1 in that on-off valve V is replaced with a micropump MP3 of which structure and operation are substantially the same as those of the pump MP1 and others.

Structures and manners other than the above are the same as those in the system A shown in FIG. 1. The parts and portions which are the same or substantially the same as those in the system A bear the same reference numbers or symbols.

For supplying the fuel liquid to the cell 1, pumps MP1 and MP2 are alternately driven. The pump MP3 has restriction passages f1 and f2 similarly to the pump structures already described, but allows passage of the liquid through it when it is not driven by the piezoelectric element PZT.

### (2) Embodiments 7 and 8

In this fuel cell system C, for smoothly removing the carbon dioxide gas generated on the anode (fuel electrode) 12 side by the electrochemical reaction in the cell 1, and thereby improving the power generation efficiency, the pumps MP1, MP2 and MP3 operate in one of manners in the embodiments 7 and 8, and the controller Cont controls the pump drive circuit D for achieving the operations in such manners.

### (2-1) Embodiment 7 (see FIG. 8(A))

As shown in FIG. 8(A), the group of pumps MP1 and MP2 is driven positively and alternately with respect to the pump MP3 which is also driven positively. When the pumps MP1 and MP2 are positively and alternately driven, the anode chamber 14 attains the pressurized state. When the pumps MP1 and MP2 stop and the pump MP3 is positively driven, the anode chamber 14 enters the depressurized (negative pressure) state.

By repeating the pressurization and depressurization in the anode chamber 14, the carbon dioxide gas can be compressed and expanded for easy movement, and can be discharged from the vents 143 while supplying the fuel liquid to the anode 12.

The liquid-gas separator F1 removes the carbon dioxide gas mixed into the liquid flowing from the fuel liquid collecting port 142, and the liquid-gas separator F2 removes the carbon dioxide gas mixed into the liquid which may flow from the fuel liquid supply port 141.

The impurities in the fuel liquid and the by-products produced by the reaction become easy to move, and are smoothly discharged from the anode chamber.

As described above, the fuel liquid is supplied while efficiently discharging the carbon dioxide gas.

### (2-2) Embodiment 8 (see FIG. 8(B))

As shown in FIG. 8(B), the pumps MP1 and MP2 are driven alternately to each other, the group of pumps MP1 and MP2 is driven positively and continuously, and the pump MP3 is driven reversely and intermittently.

When the pump MP3 is reversely driven, the pressure in the anode chamber 14 can be raised. When the pump MP3 stops, the pressure in the anode chamber 14 lowers from the raised pressure.

By the pressurization and depressurization in the anode chamber 14, the carbon dioxide gas can be compressed and expanded for easy movement, and can be discharged from the vents 143 while supplying the fuel liquid to the anode 12.

The liquid-gas separator F1 removes the carbon dioxide gas mixed into the liquid flowing from the fuel liquid collecting port 142, and the liquid-gas separator F2 removes the carbon dioxide gas mixed into the liquid which may flow from the fuel liquid supply port 141.

The impurities in the fuel liquid and the by-products produced by the reaction become easy to move, and are smoothly discharged from the anode chamber.

As described above, the fuel liquid is supplied while efficiently discharging the carbon dioxide gas.

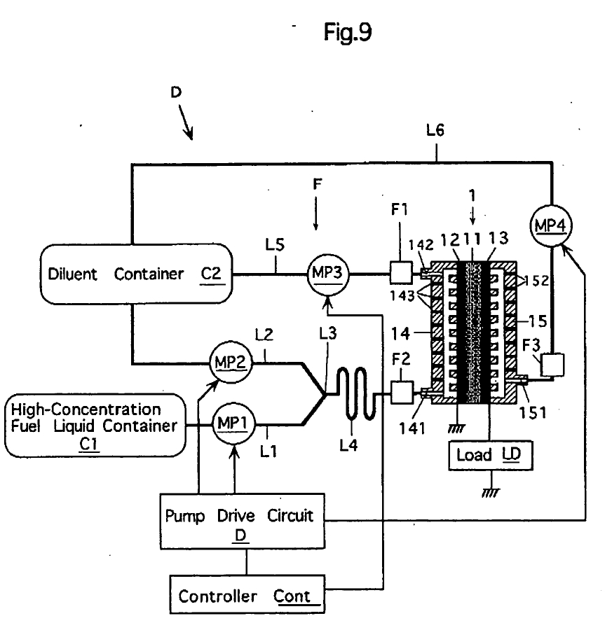

### Fuel Cell System in FIG. 9 and Embodiments 9-11 Based on It>

(1) Fuel Cell System in FIG. 9

A fuel cell system D of a structure shown in FIG. 9 differs from the fuel cell system C shown in FIG. 7 in that the pumps MP1 and MP2 are simultaneously driven for supplying the fuel liquid to the cell 1, and the-mixture passage L4 has a meandering and thus long form for ensuring the mixing of the high-concentration fuel liquid and the diluent.

Structures and manners other than the above are the same as those in the system C shown in FIG. 7. The parts and portions which are the same or substantially the same as those in the system C bear the same reference numbers or symbols.

### (2) Embodiments 9-11

In this fuel cell system D, for smoothly removing the carbon dioxide gas generated on the anode (fuel electrode) 12 side by the electrochemical reaction in the cell 1, and thereby improving the power generation efficiency, the pumps MP1, MP2 and MP3 operate in any one of manners in the embodiments 9-11, and the controller Cont controls the pump drive circuit D for achieving the operations in such manners.

(2-1) Embodiment 9 (see FIG. 10(A))

As shown in FIG. 10(A), the group of the pumps MP1 and MP2 are driven positively and alternately with respect to the pump MP3. When the pumps MP1 and MP2 are positively and simultaneously driven, the anode chamber 14 attains the pressurized state. When the pumps MP1 and MP2 stop and the pump MP3 is positively driven, the anode chamber 14 enters the depressurized (negative pressure) state.

By repeating the pressurizing and depressurizing of the anode chamber 14, the carbon dioxide gas can be compressed and expanded for easy movement, and can be discharged from the vents 143 while supplying the fuel liquid to the anode 12. The liquid-gas separator F1 removes the carbon dioxide gas mixed into the liquid flowing from the fuel liquid collecting port 142, and the liquid-gas separator F2 removes the carbon dioxide gas mixed into the liquid which may flow from the fuel liquid supply port 141.

The impurities in the fuel liquid and the by-products produced by the reaction become easy to move, and are smoothly discharged from the anode chamber.

As described above, the fuel liquid is supplied while efficiently discharging the carbon dioxide gas.

(2-2) Embodiment 10 (see FIG. 10(B))

As shown in FIG. 10(B), the pumps MP1 and MP2 are driven simultaneously and positively, and the pump MP3 is driven reversely and intermittently. When the pump MP3 is reversely driven, the pressure in the anode chamber 14 can be raised.

471 When the pump MP3 stops, the pressure in the anode chamber 14 lowers from the raised pressure. The liquid-gas separator F1 removes the carbon dioxide gas mixed into the liquid flowing from the fuel liquid collecting port 142, and the liquid-gas separator F2 removes the carbon dioxide gas mixed into the liquid which may flow from the fuel liquid supply port 141.

The impurities in the fuel liquid and the by-products produced by the reaction become easy to move, and are smoothly discharged from the anode chamber.

As described above, the fuel liquid is supplied while efficiently discharging the carbon dioxide gas.

(2-3) Embodiment 11 (see FIG. 10(C))

In the fuel cell system D shown in FIG. 9, the supply of the fuel liquid and the removal of the carbon dioxide gas also can be performed as follows.

491 As shown in FIG. 1O(C), the pump MP3 is driven positively and alternately to the reverse driving of the pumps MP1 and MP2. Thereby, the fuel liquid is supplied to the anode chamber 14 while keeping the negative pressure in the anode chamber 14. Also, the forward and reverse flows occur in the anode chamber 14 so that the adhesion of the carbon dioxide gas to the anode 12 and others is suppressed, and thereby the carbon dioxide gas can be smoothly removed.

A negative pressure can be varied by selecting at least one of the pump drive waveform of the pump MP3 and the pump drive waveform of the pumps MP1 and MP2.

The positive driving of the pumps MP1 and MP2 can be performed alternately to the reverse driving of the pump MP3. Thereby, the fuel supply into the anode chamber is performed while maintaining the positive pressure in the anode chamber 14. Also, the forward and reverse flows can be produced in the anode chamber 14. Thereby, the adhesion of the carbon dioxide gas to the anode 12 and others can be suppressed, and thereby the carbon dioxide gas can be smoothly removed.

In this case, the pump drive waveform of at least the pump MP3 or the pumps (MP1 and MP2) is selected so that the positive pressure can be varied.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A fuel cell system comprising:
a fuel cell including a cell body having an electrolyte membrane held between a fuel electrode and an oxygen electrode, and a fuel supply chamber neighboring to the fuel electrode of said cell body, and having a fuel liquid supply port; and
a fuel liquid supply portion for supplying a fuel liquid into said fuel supply chamber through the fuel liquid supply port of said fuel supply chamber, wherein
for removing a gas produced on the fuel electrode side of said cell body, the fuel liquid is supplied into the fuel supply chamber from the fuel liquid supply portion while causing pressure variations in said fuel supply chamber and/or causing forward and reverse flows of the liquid in said fuel supply chamber.

2. The fuel cell system according to claim 1, wherein
the supply of the fuel liquid to said fuel supply chamber is performed to cause said pressure variations in the fuel supply chamber and also to produce the forward and reverse flows of said liquid in the fuel supply chamber for removing the gas produced on the fuel electrode side of said cell body.

3. The fuel cell system according to claim 1, wherein
the pressure variations in said fuel supply chamber are positive and negative pressure variations caused by repetition of the positive and negative pressures.

4. The fuel cell system according to claim 1, wherein
the pressure variations in said fuel supply chamber are positive pressure variations caused by repetitive variations in magnitude of the positive pressure.

5. The fuel cell system according to claim 1, wherein
the pressure variations in said fuel supply chamber are negative pressure variations caused by repetitive variations in magnitude of the negative pressure.

6. A fuel cell system comprising:
a fuel cell including a cell body having an electrolyte membrane held between a fuel electrode and an oxygen electrode, and a fuel supply chamber neighboring to the fuel electrode of said cell body, and having a fuel liquid supply port and a fuel liquid collecting port;
a fuel liquid supply portion including a reversely operable feed pump supplying a fuel liquid into said fuel supply chamber through the fuel liquid supply port of said fuel supply chamber;
a valve connected to said fuel liquid collecting port for controlling a flow rate; and
a control portion for the feed pump of said fuel liquid supply portion and said valve, wherein
said control portion controls an operation of the feed pump of said fuel liquid supply portion and the flow rate of said valve such that said fuel liquid supply portion cooperates with said valve to supply the fuel liquid to said fuel supply chamber while generating positive and negative pressure variations and forward and reverse flows of the liquid in the fuel supply chamber for removing a gas produced on the fuel electrode side of said cell body.

7. A fuel cell system comprising:
a fuel cell including a cell body having an electrolyte membrane held between a fuel electrode and an oxygen electrode, and a fuel supply chamber neighboring to the fuel electrode of said cell body, and having a fuel liquid supply port and a fuel liquid collecting port;
a fuel liquid supply portion including a feed pump supplying a fuel liquid into said fuel supply chamber through the fuel liquid supply port of said fuel supply chamber;
a valve connected to said fuel liquid collecting port for controlling a flow rate; and
a control portion for the feed pump of said fuel liquid supply portion and said valve, wherein
said control portion controls an operation of the feed pump of said fuel liquid supply portion and the flow rate of said valve such that said fuel liquid supply portion cooperates with said valve to supply the fuel liquid to said fuel supply chamber while generating positive pressure variations in the fuel supply chamber for removing a gas produced on the fuel electrode side of said cell body.

8. A fuel cell system comprising:
a fuel cell including a cell body having an electrolyte membrane held between a fuel electrode and an oxygen electrode, and a fuel supply chamber neighboring to the fuel electrode of said cell body, and having a fuel liquid supply port;
a fuel liquid supply portion including a reversely operable feed pump supplying a fuel liquid into said fuel supply chamber through the fuel liquid supply port of said fuel supply chamber; and
a control portion for the feed pump of said fuel liquid supply portion, wherein
said control portion controls an operation of the feed pump of said fuel liquid supply portion such that said fuel liquid supply portion supplies the fuel liquid to said fuel supply chamber while generating positive and negative pressure variations and forward and reverse flows of the liquid in the fuel supply chamber for removing a gas produced on the fuel electrode side of said cell body.

9. A fuel cell system comprising:
a fuel cell including a cell body having an electrolyte membrane held between a fuel electrode and an oxygen electrode, and a fuel supply chamber neighboring to the fuel electrode of said cell body, and having a fuel liquid supply port and a fuel liquid collecting port;
a fuel liquid supply portion including a feed pump supplying a fuel liquid into said fuel supply chamber through the fuel liquid supply port of said fuel supply chamber;
a collecting pump connected to said fuel liquid collecting port; and
a control portion for the feed pump of said fuel liquid supply portion and the collecting pump, wherein
said control portion controls operations of the feed pump of said fuel liquid supply portion and said collecting pump such that said fuel liquid supply portion cooperates with said collecting pump to supply the fuel liquid to said fuel supply chamber while generating positive and negative pressure variations in said fuel supply chamber for removing a gas produced on the fuel electrode side of said cell body.

10. A fuel cell system comprising:
a fuel cell including a cell body having an electrolyte membrane held between a fuel electrode and an oxygen electrode, and a fuel supply chamber neighboring to the fuel electrode of said cell body, and having a fuel liquid supply port and a fuel liquid collecting port;
a fuel liquid supply portion including a feed pump supplying a fuel liquid into said fuel supply chamber through the fuel liquid supply port of said fuel supply chamber;
a collecting pump connected to said fuel liquid collecting port; and
a control portion for the feed pump of said fuel liquid supply portion and the collecting pump, wherein
said control portion controls operations of the feed pump of said fuel liquid supply portion and said collecting pump such that said fuel liquid supply portion cooperates with said collecting pump to supply the fuel liquid to said fuel supply chamber while generating positive pressure variations in said fuel supply chamber for removing a gas produced on the fuel electrode side of said cell body.

11. A fuel cell system comprising:
a fuel cell including a cell body having an electrolyte membrane held between a fuel electrode and an oxygen electrode, and a fuel supply chamber neighboring to the fuel electrode of said cell body, and having a fuel liquid supply port and a fuel liquid collecting port;
a fuel liquid supply portion including a feed pump supplying a fuel liquid into said fuel supply chamber through the fuel liquid supply port of said fuel supply chamber;
a collecting pump connected to said fuel liquid collecting port; and
a control portion for the feed pump of said fuel liquid supply portion and the collecting pump, wherein
said control portion controls operations of the feed pump of said fuel liquid supply portion and said collecting pump to cause intermittently forward and reverse flows of the liquid in said fuel supply chamber while maintaining a negative pressure in said fuel supply chamber for removing a gas produced on the fuel electrode side of said cell body.

12. A fuel cell system comprising;
a fuel cell including a cell body having an electrolyte membrane held between a fuel electrode and an oxygen electrode, and a fuel supply chamber neighboring to the fuel electrode of said cell body, and having a fuel liquid supply port and a fuel liquid collecting port;
a fuel liquid supply portion including a feed pump supplying a fuel liquid into said fuel supply chamber through the fuel liquid supply port of said fuel supply chamber;
a collecting pump connected to said fuel liquid collecting port; and
a control portion for the feed pump of said fuel liquid supply portion and the collecting pump, wherein
said control portion controls operations of the feed pump of said fuel liquid supply portion and said collecting pump to cause intermittently forward and reverse flows of the liquid in said fuel supply chamber while maintaining a positive pressure in said fuel supply chamber for removing a gas produced on the fuel electrode side of said cell body.

13. The fuel cell system according to claim 3, wherein
the maximum value of the absolute value of the negative pressure in said fuel supply chamber is 1/10 or more of an average value of the positive pressure in said fuel supply chamber.

14. The fuel cell system according to claim 4, wherein
the positive pressure variations in said fuel supply chamber are configured to cause a pressure larger than an average pressure in the fuel supply chamber, a total time length of a period of the pressure larger than the average pressure is equal to or smaller than half a drive time of the fuel cell, and the pressure larger than the average pressure includes a pressure larger by 1.05 times than the average pressure.

15. The fuel cell system according to claim 6, wherein
said fuel cell uses the fuel liquid prepared by diluting a high-concentration fuel liquid with a diluent, said fuel liquid supply portion has a first pump for the high-concentration fuel liquid and a second pump for the diluent, and also has a mixing passage for mixing the high-concentration fuel liquid provided from the first pump with the diluent provided from the second pump, and leading them to the fuel liquid supply port of the fuel supply chamber of said fuel cell.

16. The fuel cell system according to claim 6, wherein
a liquid-gas separator separating and discharging a gas from the liquid reversely flowing from the fuel liquid supply port of the fuel supply chamber of said fuel cell toward the fuel liquid supply portion is connected between said fuel liquid supply portion and the fuel liquid supply port.

17. The fuel cell system according claim 6, wherein
a liquid-gas separator separating and discharging a gas from the liquid flowing from the fuel liquid collecting port of the fuel supply chamber of said fuel cell toward said valve is connected between the valve and the fuel liquid collecting port.

18. The fuel cell system according claim 8, wherein
said fuel cell is provided at the fuel supply chamber with a fuel liquid collecting port, and a liquid-gas separator separating and discharging a gas from the liquid flowing from the fuel liquid collecting port is connected to the fuel liquid collecting port.

19. The fuel cell system according claim 9, wherein
a liquid-gas separator separating and discharging a gas from the liquid flowing from the fuel liquid collecting port of the fuel supply chamber of said fuel cell toward the collecting pump is connected between said collecting pump and the fuel liquid collecting port.
